(19) United States
(12) Patent Application Publication
(10) Pub. No.: US 2026/0155488 A1
(43) Pub. Date: Jun. 4, 2026

(54) REINFORCED BATTERY THERMAL BARRIER AND METHOD

(71) Applicant: ASPEN AEROGELS, INC., Northborough, MA (US)

(72) Inventors: Younggyu Nam, Northborough, MA (US); John Williams, Northborough, MA (US); Lixin Wang, Northborough, MA (US); Christopher Stow, Northborough, MA (US)

(21) Appl. No.: 19/126,237

(22) PCT Filed: Jul. 24, 2023
(86) PCT No.: PCT/US2023/070841

§ 371 Date: Apr. 30, 2025

Related U.S. Application Data
(60) Provisional application No. 63/434,010, filed on Dec. 20, 2022.

(51) Int. Cl. H01M 10/658; H01M 10/653; H01M 50/204; H01M 50/233; H01M 50/291; H01M 50/293

(52) U.S. Cl. CPC H01M 10/658; H01M 10/653; H01M 50/233; H01M 50/291; H01M 50/293; H01M 50/204

(57) ABSTRACT

Various embodiments disclosed relate to a structural feature in a thermal barrier. The present disclosure includes a battery module having a stack of battery cells located within a module housing and a thermal barrier between at least two cells in the stack of battery cells. The thermal barrier can include an isolation layer and a structural feature distributed in the isolation layer. A thermal barrier for use in a battery module can include an isolation layer, the isolation layer configured to thermally isolate individual battery cells within the battery module; and a structural feature distributed within the isolation layer.

### CLAIM OF PRIORITY

This application claims priority to U.S. Provisional Patent Application No. 63/434,010, filed Dec. 20, 2022, entitled REINFORCED BATTERY THERMAL BARRIER AND METHOD, which is incorporated by reference herein in its entirety.

### TECHNICAL FIELD

The present disclosure relates generally to materials and systems and methods for preventing or mitigating thermal events, such as thermal runaway issues, in energy storage systems. In particular, the present disclosure provides thermal barrier materials. The present disclosure further relates to a battery module or pack with one or more battery cells that includes the thermal barrier materials, as well as systems including those battery modules or packs. Examples described generally may include aerogel materials.

### BACKGROUND

Lithium-ion batteries (LIBs) are widely used in powering portable electronic devices such as cell phones, tablets, laptops, power tools and other high-current devices such as electric vehicles because of their high working voltage, low memory effects, and high energy density compared to traditional batteries. However, safety is a concern as LIBs are susceptible to catastrophic failure under “abuse conditions” such as when a rechargeable battery is overcharged, over-discharged, operated at or exposed to high temperature and high pressure.

To prevent cascading thermal runaway events from occurring, there is a need for effective insulation and heat dissipation strategies to address these and other technical challenges of LIBs.

### SUMMARY OF THE DISCLOSURE

In an example, a battery module include a stack of battery cells located within a module housing; and a thermal barrier between at least two cells in the stack of battery cells, the thermal barrier including an isolation layer and a structural feature distributed in the isolation layer.

In an example, a thermal barrier for use in a battery module can include an isolation layer comprising an aerogel, the isolation layer configured to thermally isolate individual battery cells within the battery module; and a structural feature distributed within the isolation layer.

In an example, a method of making a structural feature in a thermal barrier can include removing a portion of the thermal barrier to form one or more cavities; and forming the structural feature in the one or more cavities.

In an example, a method of making a structural feature in a thermal barrier comprising an insulation can include forming the structural feature and inserting the aerogel in and around the structural feature.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1B illustrate a battery module in an example.

FIGS. 2A-2B depict an example battery module with battery cells and thermal barriers in an example.

FIGS. 3A-3C illustrate example side views of a thermal barrier made of an aerogel with structural features in an example.

FIGS. 4A-4C depict an example of how structural features can be applied to an aerogel in a thermal barrier in an example.

FIGS. 5A-5D depict examples of thermal barriers with various structural features in an example.

FIGS. 6A-6C illustrate cross-sectional views of a thermal barrier with curved ribbon structural features extending a thickness of the thermal barrier in an example.

FIGS. 7A-7C illustrate various views of a thermal barrier with flexible fiber structural features in an example.

FIGS. 8A-8B illustrate various views of a thermal barrier with heat pressed structural feature in an example.

FIGS. 9A-9B illustrate views of a thermal barrier with a structural feature in an example.

FIGS. 10A-10C illustrate views of a thermal barrier having a structure feature that is heat pressed in an example.

FIG. 11 illustrates a flow chart of a method of making a thermal barrier with a structural feature in an example.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present disclosure describes, among other things, systems and methods related to thermal barrier for battery modules. The thermal barriers can be aerogel-based thermal barriers, such as for within or around battery modules. Discussed herein, among other things, is the creation and use of a structural feature within such thermal barriers to impart shear strength and compressibility to the thermal barriers.

Thermal barriers, which can include thermally insulative layers and structures, can be used in battery modules to help regulate temperature and heat flow within such battery modules. For example, lithium-ion batteries, often used in a stack of many battery cells, can benefit from thermal regulation to prevent thermal runaway, which could cause potential fires, overheating, combustion, or other issues associated with high temperatures in such a battery module.

Such thermal barriers can be made of thermal insulation materials as discussed in detail below, such as aerogel materials. Insulation materials according to exemplary embodiments disclosed herein include ceramic materials, e.g., ceramic papers; mica materials; polymer foam materials, e.g., polyurethane foams, polyisocyanurate foam, polystyrene foam, and phenolic foam; polymer sheet materials, e.g., polypropylene sheets, polystyrene sheets, and polyisocyanurate sheets; microporous silica; ceramic fiber; mineral wool; multi-layer materials including insulative, conductive and/or compression elements; fiber glass; rubber, cementitious foam, perlite materials; and combinations thereof. These materials, while providing thermal benefits, can suffer from mechanical stress, such as within a battery cell stack. In this case, there a thermal barrier is situated, for example, between two battery cells, a high amount of shear stress can be imparted onto the thermal barrier. Moreover, the materials from which thermal barriers are made may not have the desired compressibility for large battery stacks. Mechanical degradation and/or failure of thermal barriers can cause such battery stacks to fail.

For this reason, discussed herein is the use of structural features within thermal barriers. The structural features can be inserted into and around the aerogel of the thermal barriers to impart shear strength and compressibility. The structural features can, for example, include dots, rods, tubes, lattices, nets, ribbons, frames, or other appropriate shapes that support the structural integrity of the aerogel. These structural features can be created first, and the aerogel inserted there around. Or these structural features can be formed within an already formed aerogel. These structural features can be made of polymer or plastic materials, or dielectric materials, for example polyimides, polycarbonates, polyester, or other appropriate materials with appropriate electrical and thermal properties.

The thermal barrier insulation materials, as described in various aspects below, can be used as a single heat resistant layer, or in combination with other layers that provide additional function to a multilayer configuration, such as mechanical strength, compressibility, heat dissipation/conduction, etc. Insulation layers described herein are responsible for reliably containing and controlling heat flow from heat-generating parts in small spaces and to provide safety and prevention of fire propagation for such products in the fields of electronic, industrial, and automotive technologies.

In many embodiments of the present disclosure, the insulation layer functions as a flame/fire deflector layer either by itself or in combination with other materials that enhance performance of containing and controlling heat flow. For example, the insulation layer may itself be resistant to flame and/or hot gases and further include entrained particulate materials that modify or enhance heat containment and control.

A highly effective insulation layer can include an aerogel. Aerogels describe a class of material based upon their structure, namely low density, open cell structures, large surface areas (often 900 m²/g or higher) and sub nanometer scale pore sizes. The pores may be filled with gases such as air. Aerogels can be distinguished from other porous materials by their physical and structural properties. Although an aerogel material is an exemplary insulation material, the invention is not so limited. Other thermal insulation material layers may also be used in aspects of the present disclosure.

Selected aspects of aerogel formation and properties are described. In several aspects, a precursor material is gelled to form a network of pores that are filled with solvent. The solvent is then extracted, leaving behind a porous matrix. A variety of different aerogel compositions are known, and they may be inorganic, organic, and inorganic/organic hybrid. Inorganic aerogels are generally based upon metal alkoxides and include materials such as silica, zirconia, alumina, and other oxides. Organic aerogels include, but are not limited to, urethane aerogels, resorcinol formaldehyde aerogels, and polyimide aerogels.

Inorganic aerogels may be formed from metal oxide or metal alkoxide materials. The metal oxide or metal alkoxide materials may be based on oxides or alkoxides of any metal that can form oxides. Such metals include, but are not limited to silicon, aluminum, titanium, zirconium, hafnium, yttrium, vanadium, cerium, and the like. Inorganic silica aerogels are traditionally made via the hydrolysis and condensation of silica-based alkoxides (such as tetraethoxylsilane), or via gelation of silicic acid or water glass. Other relevant inorganic precursor materials for silica based aerogel synthesis include, but are not limited to metal silicates such as sodium silicate or potassium silicate, alkoxysilanes, partially hydrolyzed alkoxysilanes, tetraethoxylsilane (TEOS), partially hydrolyzed TEOS, condensed polymers of TEOS, tetramethoxylsilane (TMOS), partially hydrolyzed TMOS, condensed polymers of TMOS, tetra-n-propoxysilane, partially hydrolyzed and/or condensed polymers of tetra-n-propoxysilane, polyethylsilicates, partially hydrolyzed polyethysilicates, monomeric alkylalkoxy silanes, bis-trialkoxy alkyl or aryl silanes, polyhedral silsesquioxanes, or combinations thereof.

In certain embodiments of the present disclosure, pre-hydrolyzed TEOS, such as Silbond H-5 (SBH5, Silbond Corp), which is hydrolyzed with a water/silica ratio of about 1.9-2, may be used as commercially available or may be further hydrolyzed prior to incorporation into the gelling process. Partially hydrolyzed TEOS or TMOS, such as polyethysilicate (Silbond 40) or polymethylsilicate may also be used as commercially available or may be further hydrolyzed prior to incorporation into the gelling process.

Inorganic aerogels can also include gel precursors comprising at least one hydrophobic group, such as alkyl metal alkoxides, cycloalkyl metal alkoxides, and aryl metal alkoxides, which can impart or improve certain properties in the gel such as stability and hydrophobicity. Inorganic silica aerogels can specifically include hydrophobic precursors such as alkylsilanes or arylsilanes. Hydrophobic gel precursors may be used as primary precursor materials to form the framework of a gel material. However, hydrophobic gel precursors are more commonly used as co-precursors in combination with simple metal alkoxides in the formation of amalgam aerogels. Hydrophobic inorganic precursor materials for silica based aerogel synthesis include, but are not limited to trimethyl methoxysilane (TMS), dimethyl dimethoxysilane (DMS), methyl trimethoxysilane (MTMS), trimethyl ethoxysilane, dimethyl diethoxysilane (DMDS), methyl triethoxysilane (MTES), ethyl triethoxysilane (ETES), diethyl diethoxysilane, dimethyl diethoxysilane (DMDES), ethyl triethoxysilane, propyl trimethoxysilane, propyl triethoxysilane, phenyl trimethoxysilane, phenyl triethoxysilane (PhTES), hexamethyldisilazane and hexaethyldisilazane, and the like. Any derivatives of any of the above precursors may be used and specifically certain polymeric of other chemical groups may be added or cross-linked to one or more of the above precursors.

Organic aerogels are generally formed from carbon-based polymeric precursors. Such polymeric materials include, but are not limited to resorcinol formaldehydes (RF), polyimide, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations thereof. As one example, organic RF aerogels are typically made from the sol-gel polymerization of resorcinol or melamine with formaldehyde under alkaline conditions.

Organic/inorganic hybrid aerogels are mainly comprised of (organically modified silica (“ormosil”) aerogels. These ormosil materials include organic components that are covalently bonded to a silica network. Ormosils are typically formed through the hydrolysis and condensation of organically modified silanes, R—Si(OX)₃, with traditional alkoxide precursors, Y(OX)₄. In these formulas, X may represent CH₃, C₂H₅, C₃H₇, C₄H₉; Y may represent Si, Ti, Zr, or Al; and R may be any organic fragment such as methyl, ethyl, propyl, butyl, isopropyl, methacrylate, acrylate, vinyl, epoxide, and the like. The organic components in ormosil aerogel may also be dispersed throughout or chemically bonded to the silica network.

Aerogels can be formed from flexible gel precursors. Various flexible layers, including flexible fiber-reinforced aerogels, can be readily combined, and shaped to give pre-forms that when mechanically compressed along one or more axes, give compressively strong bodies along any of those axes.

One method of aerogel formation includes batch casting. Batch casting includes catalyzing one entire volume of sol to induce gelation simultaneously throughout that volume. Gel-forming techniques include adjusting the pH and/or temperature of a dilute metal oxide sol to a point where gelation occurs. Suitable materials for forming inorganic aerogels include oxides of most of the metals that can form oxides, such as silicon, aluminum, titanium, zirconium, hafnium, yttrium, vanadium, and the like. Particularly preferred are gels formed primarily from alcohol solutions of hydrolyzed silicate esters due to their ready availability and low cost (alcogel). Organic aerogels can also be made from melamine formaldehydes, resorcinol formaldehydes, and the like.

In one aspect, aerogel materials may be monolithic, or continuous throughout a structure or layer. In other aspects, an aerogel material may include a composite aerogel material with aerogel particles that are mixed with a binder. Other additives may be included in a composite aerogel material, including, but not limited to, surfactants that aid in dispersion of aerogel particles within a binder. A composite aerogel slurry may be applied to a supporting plate such as a mesh, felt, web, etc. and then dried to form a composite aerogel structure.

As noted above, an aerogel may be organic, inorganic, or a mixture thereof. In some aspects, the aerogel includes a silica-based aerogel. One or more layers in a thermal barrier may include a reinforcement material. The reinforcing material may be any material that provides resilience, conformability, or structural stability to the aerogel material. Aspects of reinforcing materials include, but are not limited to, open-cell macroporous framework reinforcement materials, closed-cell macroporous framework reinforcement materials, open-cell membranes, honeycomb reinforcement materials, polymeric reinforcement materials, and fiber reinforcement materials such as discrete fibers, woven materials, non-woven materials, needled non-wovens, battings, webs, mats, and felts.

The reinforcement material can be selected from organic polymer-based fibers, inorganic fibers, carbon-based fibers, or a combination thereof. The inorganic fibers are selected from glass fibers, rock fibers, metal fibers, boron fibers, ceramic fibers, basalt fibers, or combination thereof. In some aspects, the reinforcement material can include a reinforcement including a plurality of layers of material.

In addition to thermal insulating layers, thermally conductive layers in combination with thermal insulating layers are effective at channeling unwanted heat to a desired external location, such as external heat dissipating fins, a heat dissipating housing, or other external structure to dissipate unwanted heat to outside ambient air. In one example, a thermally conductive layer or layers helps to dissipate heat away from a localized heat load within a battery module or pack. Examples of high thermal conductivity materials include carbon fiber, graphite, silicon carbide, metals including but not limited to copper, stainless steel, aluminum, and the like, as well as combinations thereof.

To aid in the distribution and removal of heat by, in at least one embodiment the thermally conductive layer can be coupled to a heat sink. It will be appreciated that there are a variety of heat sink types and configurations, as well as different techniques for coupling the heat sink to the thermally conductive layer, and that the present disclosure is not limited to the use of any one type of heat sink/coupling technique. For example, at least one thermally conductive layer of the multilayer materials disclosed herein can be in thermal communication with an element of a cooling system of a battery module or pack, such as a cooling plate or cooling channel of the cooling system. For another example, at least one thermally conductive layer of the multilayer materials disclosed herein can be in thermal communication with other elements of the battery pack, battery module, or battery system that can function as a heat sink, such as the walls of the pack, module, or system, or with other ones of the multilayer materials disposed between battery cells. Thermal communication between the thermally conductive layer of the multilayer materials and heat sink elements within the battery system can allow for removal of excess heat from the cell or cells adjacent to the multilayer material to the heat sink, thereby reducing the effect, severity, or propagation of a thermal event that may generate excess heat.

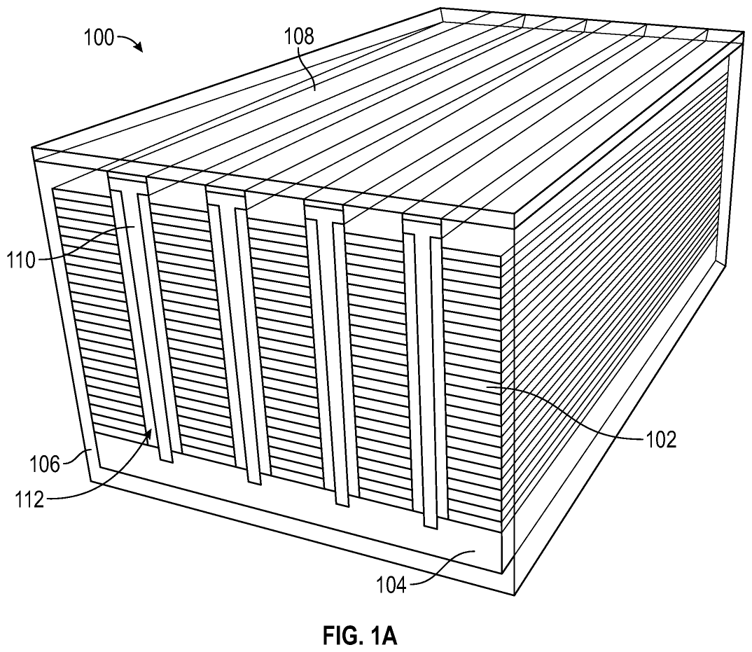

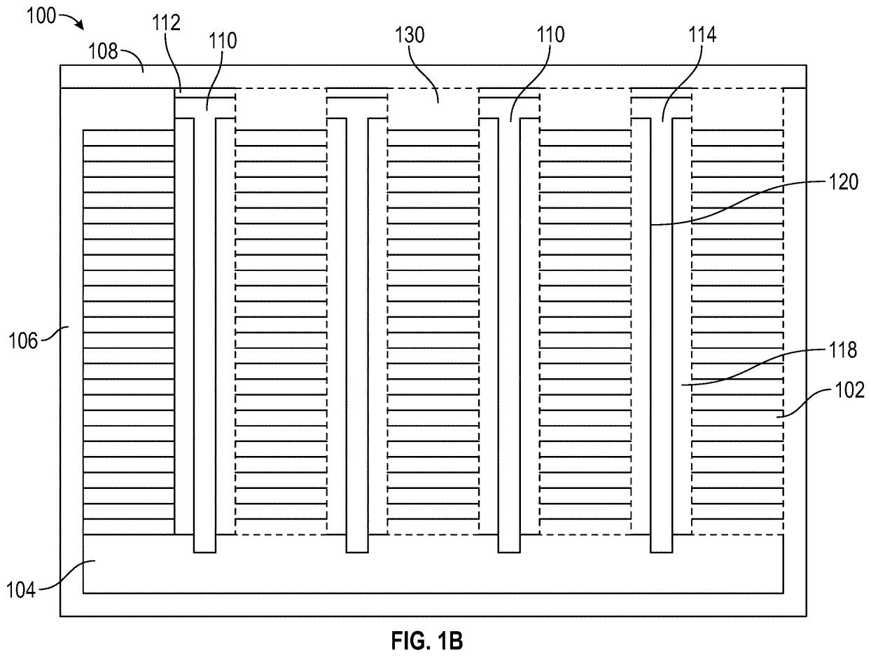

FIGS. 1A-1B illustrate a battery module 100 in an example. FIG. 1A shows one aspect of a battery module 100. The module 100 includes a stack of battery cells 102. In one example, the stack of cells 102 includes lithium-ion cells 102. Several configurations of lithium-ion cells 102 are possible. In one example, the stack of lithium-ion cells 102 includes lithium-ion pouch cells, although the invention is not so limited. A heat sink 104 is shown located on a side of the module 100, and in thermal communication with the battery cells 102. In the example of FIG. 1A, the stack of battery cells 102 are located within a module housing 106. A module cover 108 is further shown enclosing the stack of battery cells 102 within the module housing 106.

Thermal barriers 110 are shown between at least two cells in the stack of battery cells 102. In an example a thermal barrier 110 can be included between each cell in the stack of battery cells 102, although the invention is not so limited. In one example, groups of cells 102 are separated by thermal barriers 110. Inclusion of thermal barriers 110 provides a level of increased safety in the event of a thermal runaway in one or more of the cells 102. If a thermal runaway event occurs, a region affected by destruction of a failed cell 102 is contained to a region between thermal barriers 110 and/or the module housing 106. Improved thermal barriers 110 are desired to better isolate and protect adjacent regions within a battery module 100, especially in the event of thermal runaway in one or more individual cells 102.

A heat sink 104 is shown in FIG. 1A. Aspects of heat sinks 104 include, but are not limited to, passive heat sinks such as metal plates, and active heat sinks such as fluid recirculation systems that remove heat to a remote location. In the example of FIG. 1A, thermal barriers 110 interlock with the heat sink within a slot or other recess. In one example, the heat sink 104 is a separate component contained within the module housing 106. In one example, the heat sink 104 is integral with a bottom surface of the module housing 106.

FIG. 1B shows a cross section view of the battery module 100 from FIG. 1A. A thermal barrier 110 is shown including a structural support plate 112. The thermal barrier 110 also includes a module cover contact 114 located on a top end of the structural support plate 112. A thermal isolation layer 118 is shown coupled to one side of the structural support plate 112. In the aspect of FIG. 1B, a second thermal isolation layer 120 is shown coupled to an opposite side of the structural support plate 112 from the thermal isolation layer 118.

As shown in FIG. 1B, at least some of the cells 102 are separated by thermal barriers 110. A space 130 is shown above the cells 102 within the module housing 106 and the module cover 108. In the event of a thermal runaway, gasses may vent into the space above a cell 102. In one aspect cells 102 include a vent (not shown) that specifically directs gasses into the space 130. In such an event, it is desirable to contain the hot gasses, and keep them from affecting adjacent cells 102.

The battery module 100 of FIGS. 1A and 1B can include thermal barriers with one or more structural features integrated into the thermal barriers. These structural features can be integrated into the thermal barriers in various configurations, as described below.

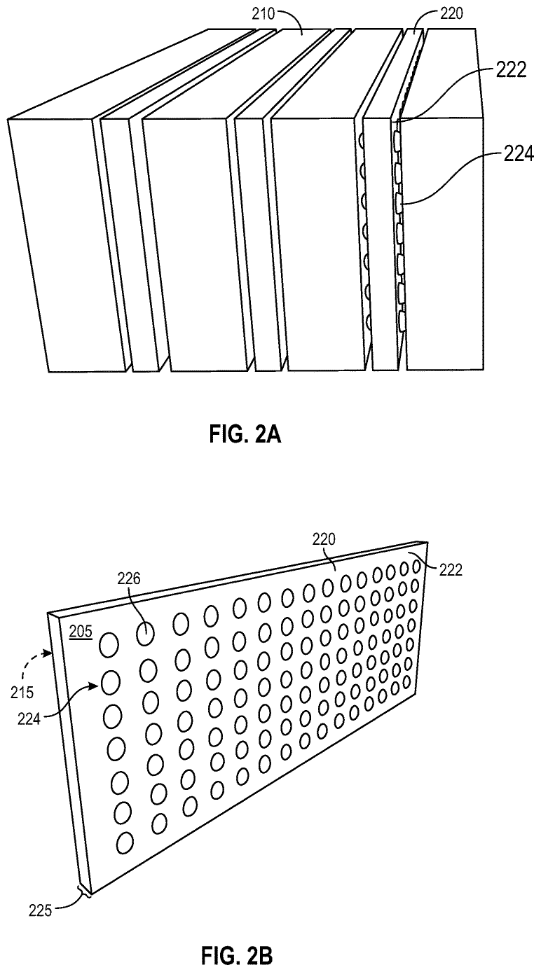

FIGS. 2A-2B depict an example battery module 200 with battery cells 210 and thermal barriers 220. The thermal barriers 220 can be single layered or multi-layered. The thermal barriers 220 can each be between two of the battery cells 210. An example thermal barrier 220 can include an aerogel 222 and a structural feature 224 including a plurality of elements 226. In some cases, the elements 226 can be rods, bars, dots, or other appropriate shapes.

Here, the battery module 200 can be a stack of battery cells 210 within a housing. The thermal barriers 220 can be aerogel materials situated between adjacent battery cells 210. The thermal barriers 220 can be subject the shear stress due to their position in between the battery cells 210. That is, the thermal barriers 220 can be subject to force tending to cause deformation of the material by slippage along a plane or planes parallel to the imposed stress.

The thermal barriers 220 can each include a first major plane 205 extending along the largest surface of the thermal barrier. The first major plane 205 can, for aspect, face one of the battery cells 210. The thermal barrier 220 can include a second major plane 215 opposite the first major plane 205. The thermal barrier 220 can have a thickness 225 extending between the first major plane 205 and the second major plane 215.

The elements 226 of the structural feature 224 can be embedded in the thickness 225 of the thermal barrier 220. The structural feature 224 can be distributed within the aerogel 222 of the thermal barriers 220. Each of the elements 226 of the structural feature 224 can be situated within the aerogel 222. The elements 226 can be situated perpendicular to the first major plane 205 and/or the second major plane 215 of the thermal barrier 220.

The structural feature 224 elements 226 can each pass through the thickness 225 of the aerogel 222 from one side of the thermal barrier 220 at the first major plane 205 to the other opposing side of the thermal barrier 220 at the second major plane 215. The elements 226 can each have a length equal to or longer than the thickness 225 of the aerogel 222.

The structural feature 224 can provide greater shear force against the adjacent battery cells 210 compared to the thermal barriers 220 without such a structural feature 224. Where the thermal barriers 220 are laminated, the structural feature 224 can provide support to the laminated thermal barriers 220 from delamination.

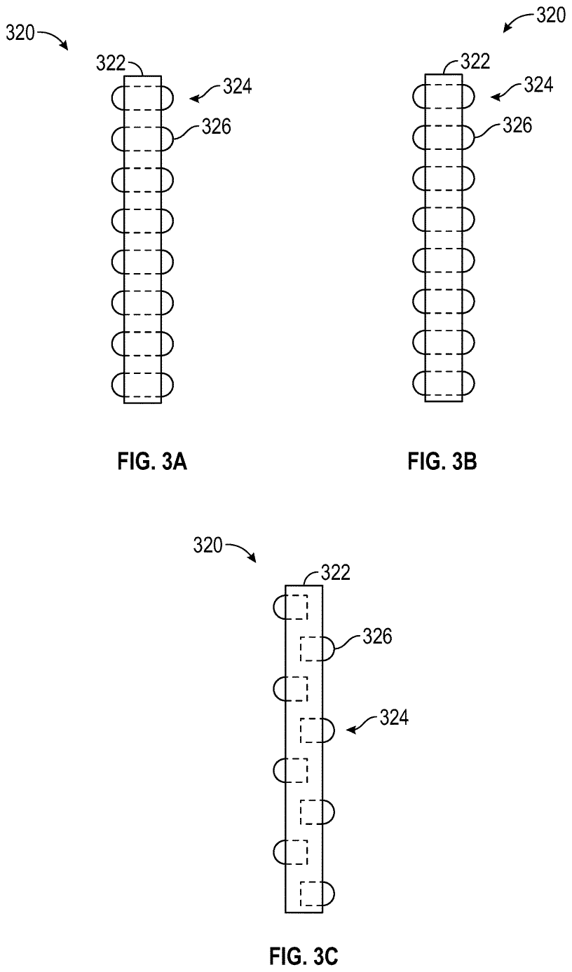

FIGS. 3A-3C illustrate example side views of a thermal barrier 320 made of an aerogel 322 with structural features 324. Here, the structural features 324 can be distributed in the aerogel 322 of the thermal barrier 320. The thermal barrier 320 can be single layered or multi-layered.

Each of the structural features 324 can pass through at least a portion of the thickness of the thermal barrier 320. Each of the structural features 324 can have a length equal to or greater than the thickness of the thermal barrier 320. The structural features 324 can provide greater shear force against battery cells (or other structures) compared to the surface of the thermal barrier 320 without the structural features 324. Similarly, the structural features 324 can provide delamination support to any laminated thermal barrier 320. Here, the structural features 324 can be individual rods 326 perpendicular to the largest surface of the thermal barrier 320.

Shown in FIG. 3A and FIG. 3B, the structural features 324 can extend through the thickness of the thermal barrier 320. In the case of FIG. 3B, the structural features 324 can be more densely situated within the aerogel 322 than those shown in FIG. 3A. The individual rods 326 pin the laminated layers of the thermal barrier 320 together, therefore preventing the delamination of the thermal barrier 320.

Shown in FIG. 3C, the structural features 324 can extend partially through the thermal barrier 320. The structural features 324 can be inserted on either side of the thermal barrier 320. Here, this can help prevent thermal conduction through the thickness of the thermal barrier 320 along the individual rods 326. The structural features 324 can be inserted from both sides of the thermal barrier 320 alternately such as to provide better compressibility. The structural features 324 can be less compressible than the thermal barrier 320.

The structural features 324 in the thermal barrier 320 can be over-molded into or onto the thermal barrier 320. The structural features 324 can be dots, rods, or bars. When over-molded into or onto the thermal barrier 320, the final shape of the structural features 324 can be flatter than the initial shape.

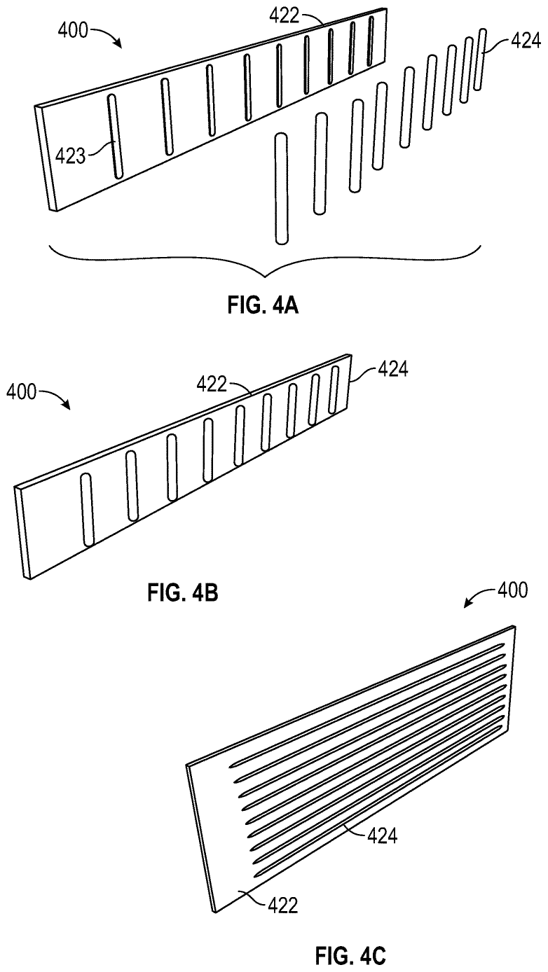

FIGS. 4A-4C depict an example of how structural features 424 can be applied to an aerogel 422 in a thermal barrier 400. For example, in FIG. 4A, an exploded view of the thermal barrier 400 shows the aerogel 422 having various vertical cavities 423 for situating the structural features 424 vertically therein. FIG. 4B, but contrast, shows an example of the thermal barrier 400 with horizontal cavities for situating the structural features 424 horizontally therein.

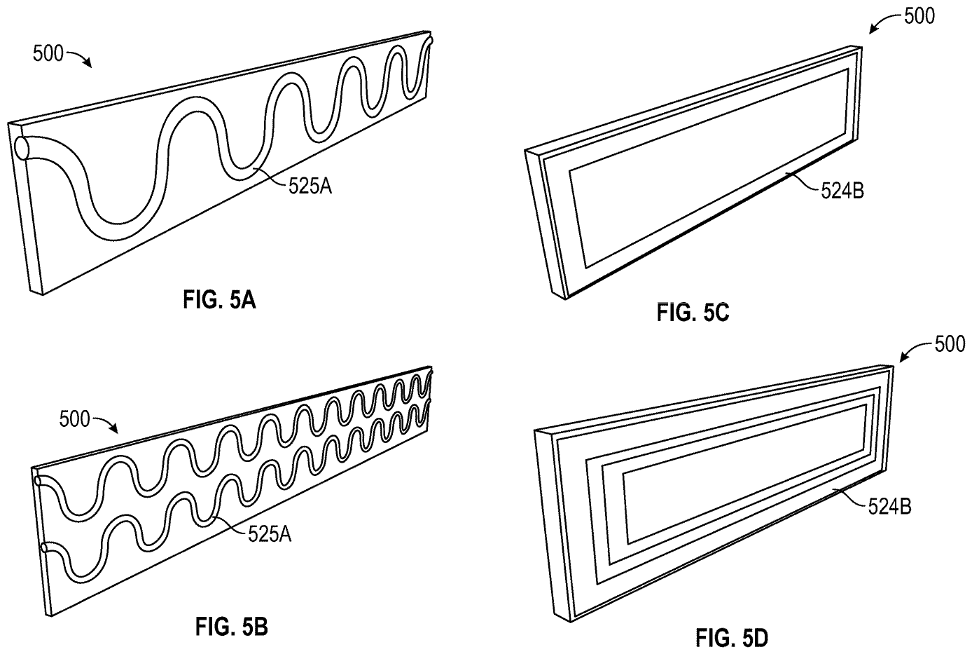

FIGS. 5A-5D depict examples of thermal barriers 500 with various structural features 524. In FIGS. 5A and 5B, the structural feature 524A can be a curved or squiggly ribbon that extends laterally along or within the thermal barrier 500. For example, the structural feature 524A can be similar in shape to a sine wave along the surface of the thermal barrier 500. In FIG. 5B, the structural feature 524A can include multiple ribbons, such as two curved ribbons vertically aligned with each other on or facing a surface of the thermal barriers 500.

In FIGS. 5C and 5D, the structural feature 524B can be a frame shape, such as a rectangular or square frame around an edge of the thermal barrier 500 on a surface thereof. In some cases, the structural feature 524B can include multiple frames, such as the double frame shown in FIG. 5D.

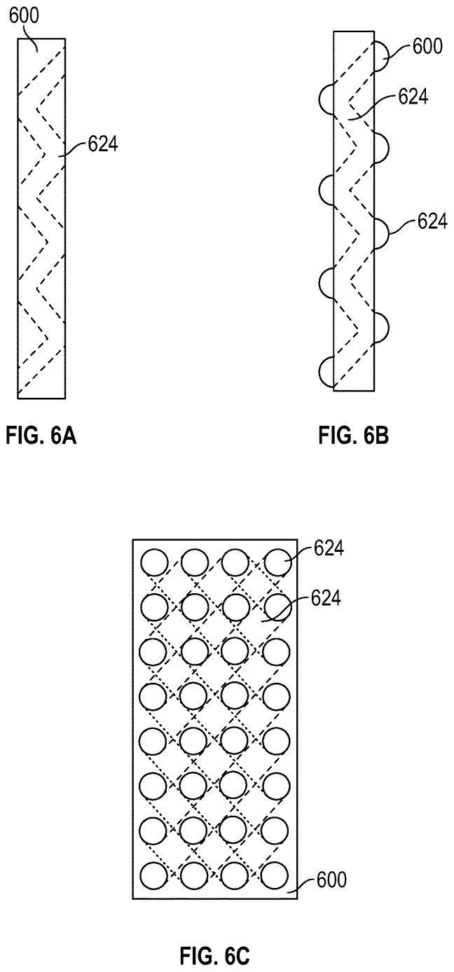

FIGS. 6A-6C illustrate various views of a thermal barrier 600 with curved ribbon structural features 624 extending through a thickness of the thermal barrier 600. The curved ribbon structural features may be nonparallel to the surfaces of the thermal barrier 600. For example, the curved ribbon structure features can form a 45° angle with the largest surface of the thermal barrier 600 as shown in FIGS. 6A and 6B. Here, the various structural features 624 can include a zig-zag that goes along a thickness of the thermal barrier 600. In some aspects, the various structural feature 624 can form an acute (e.g., 45°) or obtuse angle (e.g., 135°) with the largest surface of the thermal barrier 600. In some cases, the various structural feature 624 can form an acute (e.g., 45°) or obtuse angle (e.g., 135°) with a smaller surface of the thermal barrier 600.

In some cases, the various structural features 624 can have a thickness similar to that of the thermal barrier 600. In some cases, where the structural feature is a curved ribbon, the various structural features 624 can curve such that the peaks of the curved ribbon are adjacent and/or extend just past a surface of the thermal barrier 600. The various structural features 624 can provide better compressibility along the thickness direction of the thermal barrier 600.

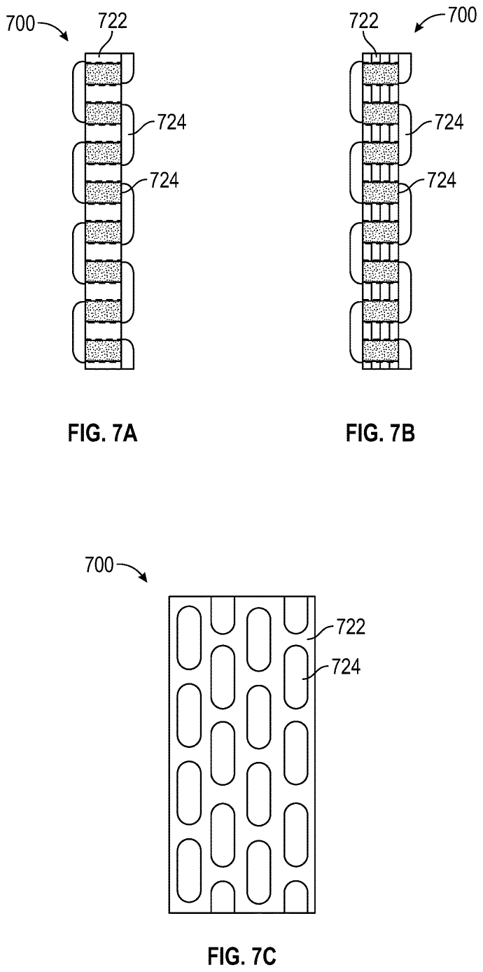

FIGS. 7A-7C illustrate various views of a thermal barrier 700 with flexible fiber structural features 724. In this aspect, the flexible fiber structural features 724 can be made of fibers that are stitched through the aerogel 722 of the thermal barrier 700. A portion of the flexible fiber structural features 724 can be situated on the surface of the thermal barrier 700. The flexible fiber structural features 724 can provide shear force with respect to adjacent cells and can prevent the thermal barrier 700 from sliding with respect to those cells. In some cases, the flexible fiber structural features 724 can be stitched vertically relative a surface of the thermal barrier 700. In some cases, the flexible fiber structural features 724 can be stitched horizontally relative a surface of the thermal barrier 700. In some cases, the flexible fiber structural features 724 can be diagonally relative a surface of the thermal barrier 700. FIG. 7B shows structural features 724 stitches through laminated thermal barrier 700.

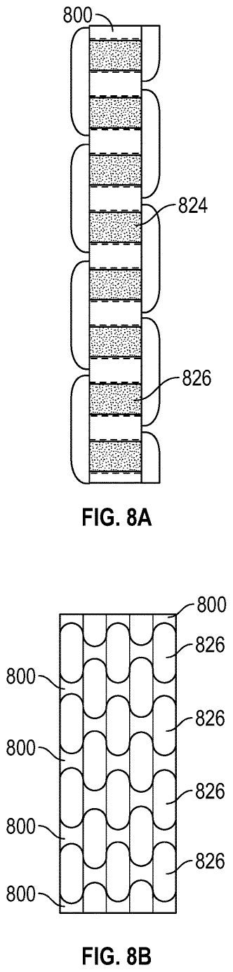

FIGS. 8A-8B illustrate various views of a thermal barrier 800 with heat pressed structural feature 824. In this case, a plurality of elements 826 can make up a single structural feature 824, such as by having the element pressed together to form a web or sheet. In some cases, a surface portion of the structural feature 824 can extend beyond the surface of the thermal barrier 800. In some cases, a portion of the structural feature 824 can remain unaffected by heat pressing.

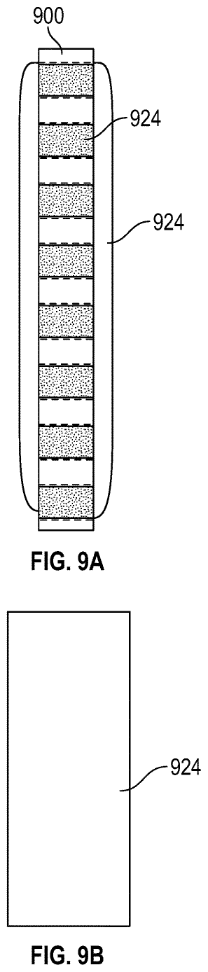

FIGS. 9A-9B illustrate views of a thermal barrier 900 with a structural feature 924. A portion of the structural feature 924 can be pressed into a connection layer. The connection layer can be situated on an external surface of the thermal barrier 900 and can increase shear force between the thermal barrier 900 and an adjacent battery cell.

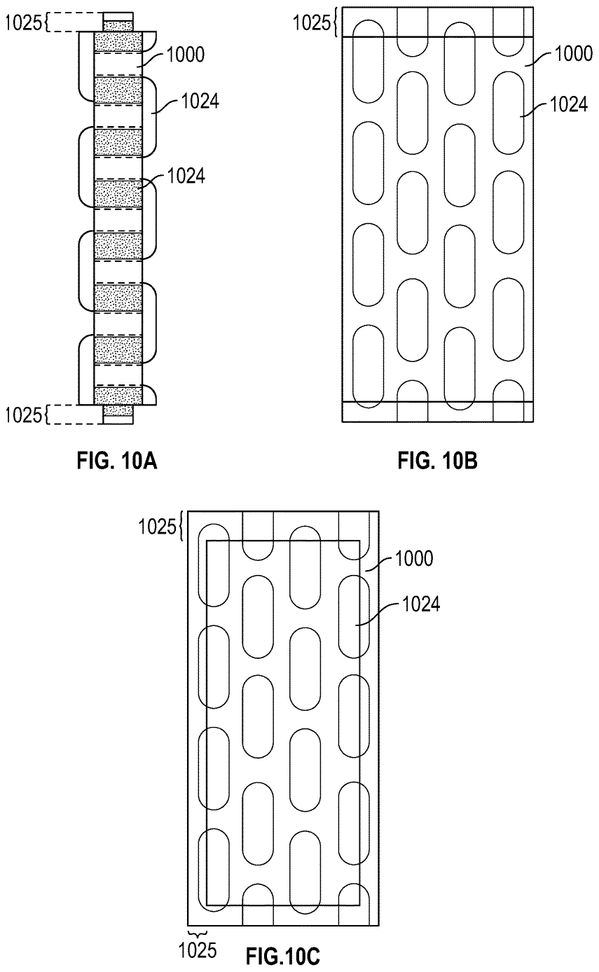

FIGS. 10A-10C illustrate views of a thermal barrier 1000 having a structure feature 1024 that is heat pressed. In this aspect, the structure feature 1024 can have edges 1025 that are thinner relative to a center of the structure feature 1024. This can allow for additional space in and around the edges of the thermal barrier 1000 where desired, such as near a tab area of an adjacent battery cell. The heat pressed portion of structure feature 1024 at the thinner edges can help maintain the thinner thickness from springing back to the original thickness.

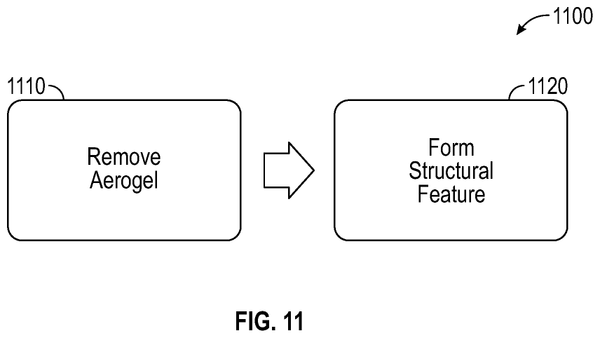

FIG. 11 illustrates a flow chart of a method of making a thermal barrier with a structural feature. For example, the method 1100 can include removing a portion of aerogel in the thermal barrier to form one or more cavities (block 1110) and forming a structural feature in the one or more cavities (block 1120).

In some cases, the structural feature can be formed by injecting an appropriate material, such as polyimide, polycarbonate, polyester, or combinations thereof. In some cases, an over-mold technique can be used. In some cases, the structural feature material can be partially embedded in the thermal barrier. In some cases, the structural feature material can be embedded into the thermal barrier such that it extends therethrough. In some cases, the method can further include heat pressing a portion of the structural feature material.

### Various Notes & Examples

Example 1 is a battery module comprising: a stack of battery cells located within a module housing; and a thermal barrier comprising an aerogel between at least two cells in the stack of battery cells, the thermal barrier including an isolation layer and a structural feature distributed in the isolation layer.
In Example 2, the subject matter of Example 1 optionally includes wherein the structural feature passes through a thickness of the isolation layer.
In Example 3, the subject matter of any one or more of Examples 1-2 optionally include wherein the structural feature comprises a thickness greater than a thickness of the thermal barrier.
In Example 4, the subject matter of any one or more of Examples 1-3 optionally include wherein the structural feature comprises a thickness substantially equal to a thickness of the thermal barrier.
In Example 5, the subject matter of any one or more of Examples 1-4 optionally include wherein the structural feature imparts shear force to the thermal barrier relative the at least two cells adjacent.
In Example 6, the subject matter of any one or more of Examples 1-5 optionally include wherein the thermal barrier comprises a single layer.
In Example 7, the subject matter of any one or more of Examples 1-6 optionally include wherein the thermal barrier comprises multiple layers.
In Example 8, the subject matter of any one or more of Examples 1-7 optionally include wherein the structural feature reduces delamination of the thermal barrier.
In Example 9, the subject matter of any one or more of Examples 1-8 optionally include wherein the structural feature comprises a plurality of rods.
In Example 10, the subject matter of any one or more of Examples 1-9 optionally include wherein the structural feature comprises a plurality of bars.
In Example 11, the subject matter of any one or more of Examples 1-10 optionally include wherein the structural feature comprises a plurality of dots.
In Example 12, the subject matter of any one or more of Examples 1 -11 optionally include wherein the structural feature comprises a plurality of features at least partially embedded in the thermal barrier.
In Example 13, the subject matter of Example 12 optionally includes wherein each of the plurality of features extends across a thickness of the thermal barrier.
In Example 14, the subject matter of any one or more of Examples 12-13 optionally include wherein one end of each of the plurality of features extend outward from the thermal barrier.
In Example 15, the subject matter of any one or more of Examples 12-14 optionally include wherein one end of each of the plurality of features extend partially through the thermal barrier.
In Example 16, the subject matter of any one or more of Examples 12-15 optionally include wherein each of the plurality of features extends across a laminated thickness of the thermal barrier.
In Example 17, the subject matter of any one or more of Examples 1-16 optionally include wherein the structural feature comprises an over-mold material.
In Example 18, the subject matter of any one or more of Examples 1-17 optionally include wherein the structural feature comprises a frame structure at least partially embedded in the thermal barrier.
In Example 19, the subject matter of any one or more of Examples 1-18 optionally include wherein the structural feature comprises a double frame structure at least partially embedded in the thermal barrier.
In Example 20, the subject matter of any one or more of Examples 1-19 optionally include wherein the structural feature comprises a zigzag structure at least partially embedded in the thermal barrier.
In Example 21, the subject matter of Example 20 optionally includes wherein the structural feature comprises a double zigzag structure at least partially embedded in the thermal barrier.
In Example 22, the subject matter of any one or more of Examples 20-21 optionally include wherein a portion of the zigzag extends beyond a surface of the thermal barrier.
In Example 23, the subject matter of any one or more of Examples 20-22 optionally include wherein the structural feature zigzag provides compressibility along a thickness of the thermal barrier.
In Example 24, the subject matter of any one or more of Examples 1-23 optionally include wherein the structural feature comprises flexible fibers.
In Example 25, the subject matter of Example 24 optionally includes wherein the flexible fibers are woven through the thermal barrier.
In Example 26, the subject matter of any one or more of Examples 1-25 optionally include wherein the structural feature is situated within the thermal barrier at a non-zero angle relative a surface of the thermal barrier.
In Example 27, the subject matter of any one or more of Examples 1-26 optionally include wherein the structural feature is heat pressed into the thermal barrier.
In Example 28, the subject matter of any one or more of Examples 1-27 optionally include wherein the structural feature comprises a connection layer pressed onto the thermal barrier.
In Example 29, the subject matter of any one or more of Examples 1-28 optionally include wherein the structural feature comprises a middle portion and one or more edges, each of the edges being thinner than the middle portion.
Example 30 is a thermal barrier for use in a battery module, the thermal barrier comprising: an isolation layer comprising an aerogel, the isolation layer configured to thermally isolate individual battery cells within the battery module; and a structural feature distributed within the isolation layer.
In Example 31, the subject matter of Example 30 optionally includes wherein the structural feature comprises a plurality of features at least partially embedded in the thermal barrier.
In Example 32, the subject matter of Example 31 optionally includes wherein the structural feature comprises a plurality of rods.
In Example 33, the subject matter of any one or more of Examples 30-32 optionally include wherein the structural feature comprises a plurality of bars.
In Example 34, the subject matter of any one or more of Examples 30-33 optionally include wherein the structural feature comprises a plurality of dots.
In Example 35, the subject matter of any one or more of Examples 30-34 optionally include wherein the structural feature comprises an over-mold material.
In Example 36, the subject matter of Example 35 optionally includes wherein the structural feature comprises a frame structure at least partially embedded in the thermal barrier.
In Example 37, the subject matter of any one or more of Examples 35-36 optionally include wherein the structural feature comprises a double frame structure at least partially embedded in the thermal barrier.
In Example 38, the subject matter of any one or more of Examples 35-36optionally include wherein the structural feature comprises a zigzag structure at least partially embedded in the thermal barrier.
In Example 39, the subject matter of any one or more of Examples 35-36optionally include wherein the structural feature comprises a double zigzag structure at least partially embedded in the thermal barrier.
In Example 40, the subject matter of any one or more of Examples 30-39 optionally include wherein the structural feature comprises flexible fibers.
In Example 41, the subject matter of any one or more of Examples 30-40 optionally include wherein the structural feature comprises a connection layer pressed onto the thermal barrier.
Example 42 is a method of making a structural feature in a thermal barrier comprising an aerogel, the method comprising: removing a portion of the aerogel to form one or more cavities; and forming the structural feature in the one or more cavities.
In Example 43, the subject matter of Example 42 optionally includes wherein forming the structural feature comprises injecting a structural material into the one or more cavities.
In Example 44, the subject matter of Example 43 optionally includes wherein the structural material comprises polyimide, polycarbonate, polyester, or combinations thereof.
In Example 45, the subject matter of any one or more of Examples 42-44 optionally include wherein forming the structural feature comprises injecting the structural feature partially into a thickness of the aerogel.
In Example 46, the subject matter of any one or more of Examples 42-45 optionally include wherein forming the structural feature comprises injecting the structural feature across a thickness of the aerogel.
In Example 47, the subject matter of any one or more of Examples 42-46 optionally include wherein forming the structural feature comprises evenly distributing the structural feature within the aerogel.
In Example 48, the subject matter of any one or more of Examples 42-47 optionally include wherein forming the structural feature comprises over-molding a structural material onto the aerogel.
In Example 49, the subject matter of any one or more of Examples 42-48 optionally include forming a connection layer by heat pressing the structural feature.

Each of these non-limiting examples can stand on its own or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain quickly the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment.

Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A battery module, comprising:
a stack of battery cells located within a module housing;
a thermal barrier between at least two cells in the stack of battery cells, the thermal barrier including an isolation layer having a major plane; and
a structural feature distributed in the isolation layer, the structural feature comprising a plurality of elements, each of the plurality of elements extending at least partially through the major plane, wherein the structural feature comprises a frame structure at least partially embedded in the thermal barrier.

2. The battery module of claim 1, wherein the isolation layer comprises an aerogel.

3. The battery module of claim 1, the isolation layer comprising a second major plane on a side opposing the major plane.

4. The battery module of claim 3, the isolation layer comprising a thickness extending between the major plane and the second major plane.

5. The battery module of claim 4, wherein the plurality of elements are embedded in the thickness.

6. The battery module of claim 4, wherein the plurality of elements extend out of the thickness.

7. (canceled)

8. (canceled)

9. (canceled)

10. The battery module of claim 1, wherein the plurality of elements comprise a unitary structure.

11. (canceled)

12. The battery module of claim 1, wherein the structural feature comprises a double frame structure at least partially embedded in the thermal barrier.

13. (canceled)

14. (canceled)

15. (canceled)

16. (canceled)

17. The battery module of claim 1, wherein the plurality of elements comprise flexible fibers.

18. The battery module of claim 17, wherein the flexible fibers are woven through the thermal barrier.

19. The battery module of claim 1, wherein the structural feature is situated within the thermal barrier at a non-zero angle relative the major plane.

20. The battery module of claim 1, wherein the structural feature is heat pressed into the thermal barrier along the major plane.

21. The battery module of claim 1, wherein the structural feature comprises a connection layer pressed onto the thermal barrier along the major plane.

22. The battery module of claim 1, wherein the structural feature comprises a middle portion and one or more edges, each of the edges being thinner than the middle portion.

23. A thermal barrier for use in a battery module, the thermal barrier comprising:
an isolation layer, the isolation layer configured to thermally isolate individual battery cells within the battery module; and
a structural feature distributed within the isolation layer, wherein the structural feature comprises a plurality of rods, bars, or dots.

24. The thermal barrier of claim 23, wherein the isolation layer comprises an aerogel.

25. The thermal barrier of claim 23, wherein the structural feature comprises a plurality of features at least partially embedded in the thermal barrier.

26. (canceled)

27. (canceled)

28. (canceled)

29. (canceled)

30. (canceled)

31. A method of making a structural feature in a thermal barrier comprising an insulation, the method comprising: removing a portion of the insulation to form one or more cavities; and forming the structural feature in the one or more cavities.

32. The method of claim 31, wherein forming the structural feature comprises injecting a structural material into the one or more cavities.

33. The method of claim 31, wherein forming the structural feature comprises over-molding a structural material onto the insulation.
